(19) United States
(12) Patent Application Publication
(10) Pub. No.: US 2013/0061305 A1
(43) Pub. Date: Mar. 7, 2013

(54) RANDOM CHALLENGE ACTION FOR AUTHENTICATION OF DATA OR DEVICES

(71) Applicants: Kelsey L. Bruso, Minneapolis, MN (US); Glen E. Newton, Eagan, MN (US)

(72) Inventors: Kelsey L. Bruso, Minneapolis, MN (US); Glen E. Newton, Eagan, MN (US)

(21) Appl. No.: 13/226,667

(22) Filed: Sep. 7, 2011

(51) Int. Cl. G06F 21/20; G06F 21/00

(52) U.S. Cl. 726/7; 726/19

(57) ABSTRACT

An authentication system is enhanced by prompting an individual to perform a randomly-selected challenge action. For example, the individual may be requested to move the device in a particular motion, after entering a username/password combination. The randomly-selected challenge action verifies the individual is located at the device, which prevents automated attacks to steal the individual's identity. The challenge action improves security by preventing attackers from spoofing an individual's authentication information. The enhanced authentication system may be used on mobile devices, such as mobile phones and laptop computers, to provide access to secure data, such as bank account information.

The instant disclosure relates to authentication devices. More specifically, this disclosure relates to biometric authentication.

### BACKGROUND

Data access on mobile devices is increasing at a rapid pace, but authenticating individuals on mobile devices presents new challenges. For example, individuals may have access to their bank account information from their mobile phone or laptop computer but the mobile device may be more easily stolen or misplaced. An unauthorized individual who finds or steals the mobile device should be prevented from accessing secure data through the mobile device. There is no guarantee that the user of the mobile device is an individual authorized to view the information.

One conventional solution is to include user name and password authentication on the mobile device. This authentication technique tests an individual's knowledge and assumes that an individual with the correct user name and password is authorized to access the information. However, the user name and password combinations may be stolen if the media recording the combinations is insecure, or stolen by a hidden camera, or stolen by keystroke recording, or stolen by other social engineering techniques. Additionally, an authorized individual may forget cryptic information such as user name and password combinations.

Another conventional solution uses biometric authentication to test an individual's physical presence. For example, a fingerprint may be stored and the protected information is unavailable unless a user's fingerprint matches the fingerprint of an authorized individual. Although biometric authentication is more difficult to spoof than a username and password combination, biometric authentication is not immune to attacks. For example, a user may mimic an authorized individual's finger with gummy bear jelly placed on the attacker's finger. Additionally, in more extreme cases, an attacker may employ the severed limb exploit by detaching an authorized individual's finger. Conventional biometric authentication may produce false negatives as a result of temperature, humidity, air pressure, aging, pregnancy, injury, or illness. Similarly, when facial recognition is employed to authenticate an individual, the authentication may be spoofed by capturing an image of a photograph.

### SUMMARY

According to one embodiment, a method includes requesting authentication information for an individual. The method also includes receiving authentication information for the individual. The method further includes requesting the individual perform a challenge action. The method also includes receiving a response to the challenge action request from the individual. The method further includes authenticating the individual based at least on the authentication information and the challenge action response.

According to another embodiment, a computer program product includes a non-transitory computer-readable medium having code to request authentication information for an individual. The medium also includes code to receive authentication information for the individual. The medium further includes code to request the individual perform a challenge action. The medium also includes code to receive a response to the challenge action request from the individual. The medium further includes code to authenticate the individual based at least on the authentication information and the challenge action response.

According to yet another embodiment, a system includes a memory, a sensor, and a processor. The processor is coupled to the memory and coupled to the sensor. The processor is configured to request authentication information for an individual. The processor is also configured to receive authentication information for the individual. The processor is further configured to request the individual perform a challenge action. The processor is also configured to receive a response to the challenge action request from the individual through the sensor. The processor is further configured to authenticate the individual based at least on the authentication information and the challenge action response.

According to a further embodiment, a method includes requesting authentication information for an individual. The method also includes receiving authentication information for the individual. The method further includes presenting the individual with a random challenge action. The method also includes receiving a response to the challenge action request from the individual. The method further includes authenticating the individual based at least on the authentication information and the challenge action response.

According to another embodiment, a computer program product includes a non-transitory computer-readable medium having code to request authentication information for an individual. The medium also includes code to receive authentication information for the individual. The medium further includes code to preset the individual with a random challenge action. The medium also includes code to receive a response to the challenge action from the individual. The medium further includes code to authenticate the individual based at least on the authentication information and the challenge action response.

According to yet another embodiment, a system includes a memory, a sensor, and a processor. The processor is coupled to the memory and coupled to the sensor. The processor is configured to request authentication information for an individual. The processor is also configured to receive authentication information for the individual. The processor is further configured to present the individual with a random challenge action. The processor is also configured to receive a response to the challenge action from the individual through the sensor. The processor is further configured to authenticate the individual based at least on the authentication information and the challenge action response.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating an exemplary method for authenticating an individual with an assigned challenge action according to one embodiment of the disclosure.

FIGS. 2A-2B are animations illustrating exemplary gesture motions for a challenge action response according to one embodiment of the disclosure.

FIG. 3 is a call diagram illustrating authentication of an individual by a server through a client device according to one embodiment of the disclosure.

FIG. 4 is a call diagram illustrating authentication of an individual by a server through a client device according to one embodiment of the disclosure.

FIG. 5 is a flow chart illustrating an exemplary method for authenticating an individual with a random challenge action according to one embodiment of the disclosure.

FIG. 6 is block diagram illustrating a data management system configured to store databases, tables, and/or records according to one embodiment of the disclosure.

FIG. 7 is a block diagram illustrating a data storage system according to one embodiment of the disclosure.

FIG. 8 is a block diagram illustrating a computer system according to one embodiment of the disclosure.

### DETAILED DESCRIPTION

Security may be improved by adding additional requirements for an individual to authenticate before gaining access to secure data or a device. Conventionally, only one layer of security, a username/password combination, is required of a user before gaining access to secure data or a device. An additional layer of security may be a challenge action requesting the user to perform an action with the device after receiving the username/password combination. The action may be detected through one or more of the sensors embedded in the device.

According to one embodiment, the challenge action may be known only to a specific individual. Thus, even if an imposter obtains the username/password combination for an individual, the imposter will be unable to authenticate because the imposter does not know the challenge action assigned to the individual associated with the username/password combination.

According to another embodiment, the challenge action may be a randomly-selected motion gesture to be performed by the individual to ensure the individual is a real person. The challenge action prevents an automated system from attempting to hack into secure data or a device, because the automated system is unable to generate a response to the challenge action.

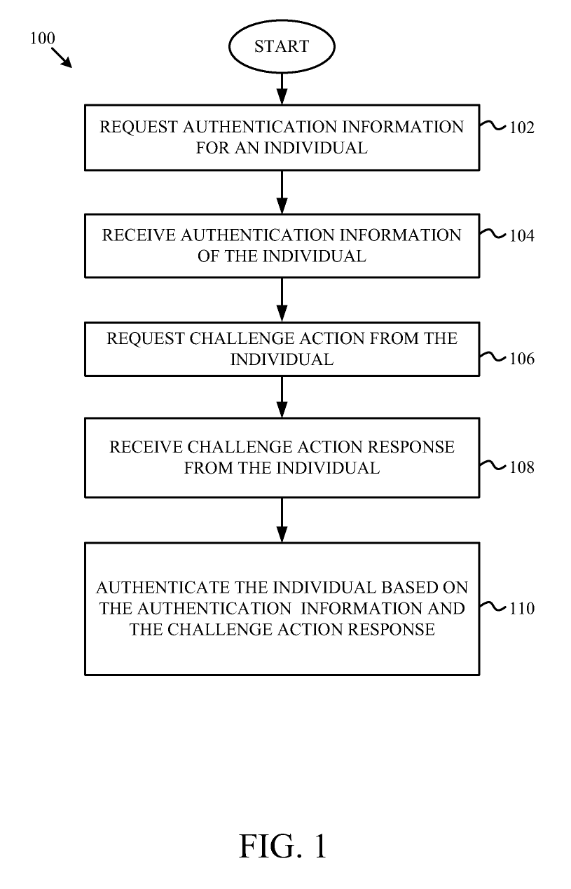

FIG. 1 is a flow chart illustrating an exemplary method 100 for authenticating an individual with an assigned challenge action according to one embodiment of the disclosure. At block 102 authentication information for an individual that is attempting access to secure data or a secure device is requested. The request for authentication information may be presented when a user first activates a device or attempts to exit a lock screen on the device. Alternatively, the request for authentication information may be presented only when a user attempts to access secure data on the device. At block 104 authentication information is received from the individual such as, for example, a fingerprint, an iris image, a picture, and/or a username/password combination.

At block 106 a challenge action is requested from the individual. For example, a prompt may be displayed to the user to “perform the challenge action now.” The challenge action may be one of moving the device in a circle clockwise, moving the device in a circle counter-clockwise, shaking the device, shaking the device with a twisting motion, moving the device in a figure-eight pattern, moving the device back and forth at waist level, and placing the device on top of the individual's head. Although these examples are provided other motions may be selected as challenge actions.

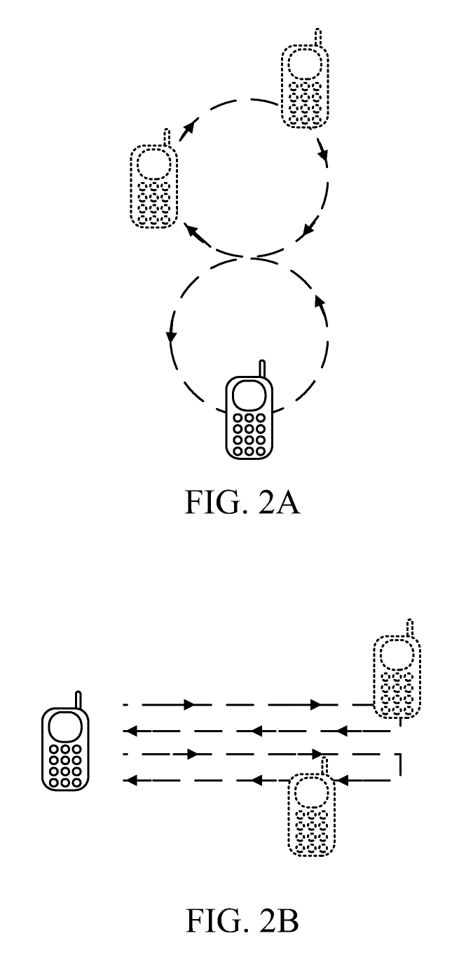

FIGS. 2A-2B are animations illustrating exemplary gesture motions for a challenge action response according to one embodiment of the disclosure. FIG. 2A illustrates a challenge action response in the form of a figure-eight motion. FIG. 2B illustrates a challenge action response in the form of moving the device back and forth at waist level.

Referring back to FIG. 1, each individual may have a custom challenge action for block 106 selected by either the individual or an administrator when the individual's authentication credentials are created. For example, when an individual is first assigned a device, the individual may select a challenge action that only the individual knows. The individual may choose actions which the individual feels confident to perform, based on any physical limitations. According to one embodiment, the request for the challenge action presented on the device does not reveal the specific challenge action for the individual.

For example, if the individual's challenge action is to move the device in a figure-eight pattern, the device may display a prompt indicating “please perform your challenge action.” If an imposter impersonating the individual identified by the authentication information at block 102 attempts to access the device, the imposter likely does not know the challenge action. Thus, the imposter may incorrectly move the device in a circle counter-clockwise, and the imposter will be denied access.

At block 108 the challenge action response is received from the individual. The response may be received through a sensor, such as a still camera, a motion camera, a microphone, an accelerometer, and/or a gyroscope. The challenge action response may be recorded by an accelerometer to determine the motion of the device. In another example, the motion of the device may be determined by recording a video from the motion camera, capturing a series of still pictures from the still camera, or measuring the Doppler shift of sounds captured through the microphone.

According to one embodiment, the challenge action response may be a combination of responses or a series of responses of the same type. For example, the user may be requested to repeat the challenge action a number of times. The number of repeats may be assigned to the individual just as the challenge action or the number of repeats may be randomly selected when the challenge action is requested at block 106.

At block 110 the individual is authenticated based, in part, on the authentication information and the challenge action response. According to one embodiment, the authentication may also be based on location information available from, for example, a global positioning system (GPS) receiver. When the individual is authenticated the individual is granted access to the secure data or the device. When authentication of the individual fails an error may be reported to the individual, and the individual may be prompted to attempt authentication again.

The authentication may be performed locally on the device accessed by the individual. The authentication may also be performed remotely on a server in communication with the device. For example, if the device is a mobile device such as, for example, a laptop computer or a mobile phone, hardware on the mobile device may record the authentication information and the challenge action response and transmit the information and response to a server. The server processes the information and response to generate an authentication message transmitted to the mobile device. The authentication message instructs the mobile device to allow or disallow access to secure data or the device by the individual.

Thus, the authentication process may include steps performed by an authentication server and a client device. According to one embodiment, the steps for authentication on the client device may be integrated into a client plug-in for access on the client device. The plug-in allows applications from different manufacturers executing on the device to perform authentication through the plug-in allowing a single authentication server to allow or disallow access to different types of secure data. The plug-in may be used to perform authentication for access to data such as, for example, bank data.

A bank may provide a mobile application to allow a customer through a mobile phone to access bank account information such as balances and to perform money transfers. The combination of the authentication information and the challenge action response ensures that the individual accessing the secure data or the device was present at the mobile device and reduces the likelihood of or prevents an imposter from gaining access to the secure data or the device.

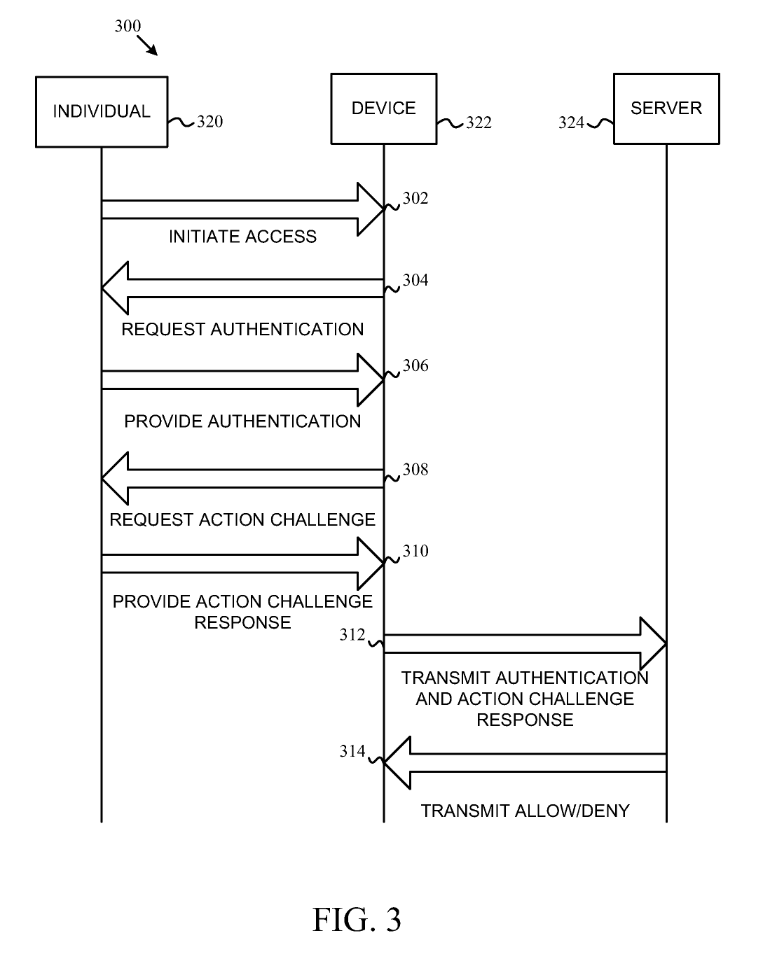

FIG. 3 is a call diagram 300 illustrating authentication of an individual by a server through a client device according to one embodiment of the disclosure. An individual 320 initiates access of a device 322 at call 302. At call 304 the device 322 requests authentication information from the individual 320. The individual 320 provides authentication information at call 306. The device 322 requests a challenge action at call 308, and the individual 320 provides a challenge action response at call 310. The device 322 then transmits the authentication information and the challenge action response, such as an accelerometer log or a video, to the server 324 at call 312. The authentication information and challenge action response may be encrypted during transfer to the server 324 with, for example, 128-bit secure sockets layer (SSL) or transport layer security (TLS) encryption. The server 324 responds at call 314 with an authentication message including an allow or deny instruction.

The device 322 may allow access to the device or secure data depending on the response received from the server 324. The server 324 may also keep records of the authentication and challenge action responses transmitted for the individual 320 and the device 322. For example, after too many access attempts are made by a purported individual 320 the credentials of the individual 320 may be locked-out. Thus, the individual 320 may no longer access the device or secure data until an administrator resets the account. In another example, if a device 322 has made too many failed authentication transmissions the device 322 may be prohibited from further communications with the server 324 until an administrator resets the account.

The server 324 may transmit additional data to the device 322 along with the allow/deny response at call 314. For example, the server 324 may transmit configuration information for the device 322 to configure the device 322 for use by the individual 320. For example, the server 324 may transmit menu and background configurations for the device 322. The server 324 may also transmit security configurations to the device 322, such as available data storage locations and application permissions.

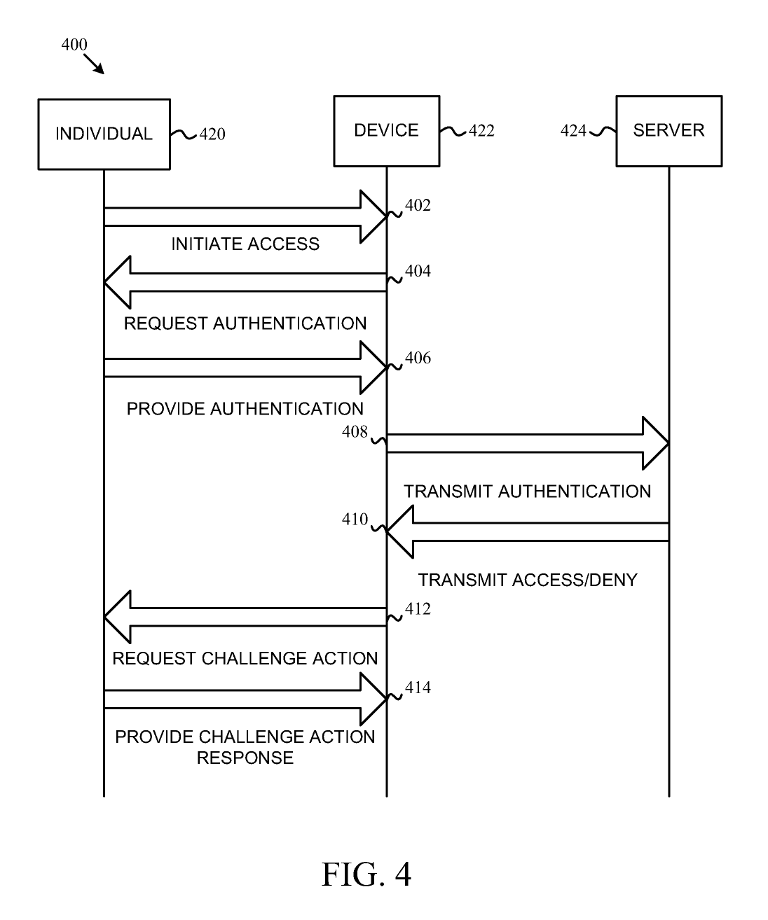

According to another embodiment, the challenge action response may not be transmitted from the client to the server during the authentication process. This embodiment may transmit less data, resulting in quicker authentication process. For example, sensor logs or video files are analyzed locally, rather than on the server. FIG. 4 is a call diagram 400 illustrating authentication of an individual by a server through a client device according to one embodiment of the disclosure. At call 402 an individual 420 initiates access to a device 422. The device 422 requests authentication information from the individual 420 at call 404, and at call 406 the individual 420 provides authentication information. The device 422 transmits the authentication information to the server 424 at call 408, and the server 424 responds with an allow or deny message at call 410. The call 410 may also include information, such as an instruction to the device 422 to present or not present a challenge action. The call 410 may further include a message for the device 422 to present to the individual 420 before the challenge action.

The call 410 may also include an identification of the particular challenge action associated with the individual 420 identified by the authentication information received by the server 424 at call 408. The device 422 may store the particular challenge action temporarily without presenting the information to the individual 420. Thus, the device 422 may perform the step of verifying the challenge action response without contacting the server 424 a second time.

At call 412 the device 422 prompts the individual 420 for a challenge action, and at call 414 the individual 420 performs the challenge action. The device 422 then verifies that the challenge action response at call 414 matches the particular challenge action received from the server 424 at call 410. The device 422 may decide whether to allow or deny access based on the response at call 414.

The device motion gestural challenge action and response adds a second layer of security on top of standard authentication procedures such as username/password combinations and biometrics. This authentication component may be used in an environment that is not suitable for voice or video-based authentication. In addition, this authentication component is resistant to the rejection of legitimate authentication attempts that may be caused by biometric changes over time, such as injuries, aging, pregnancy, and illness.

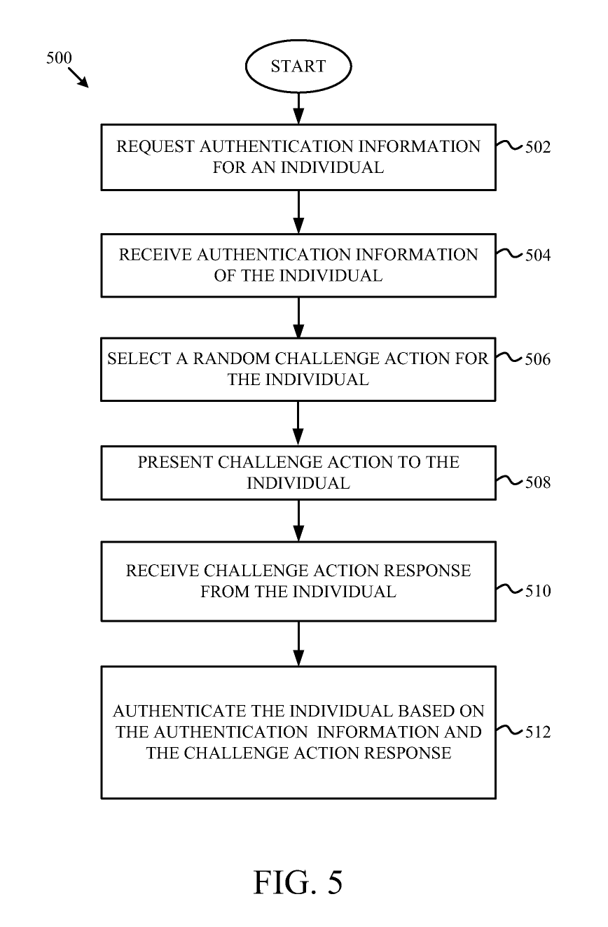

FIG. 5 is a flow chart illustrating an exemplary method 500 for authenticating an individual with a random challenge action according to one embodiment of the disclosure. At a block 502 authentication information is requested from an individual. At block 504 the authentication information is received from the individual. At block 506 a random challenge action for the individual is selected. The random challenge action may be selected from one of the motions discussed above or illustrated in FIG. 2. Preferably, the action is easily described, easily taught, and easily performed by the individual in a wide range of settings and environments. At block 508 the challenge action is presented to the individual. For example, a prompt may be displayed to the user indicating “For authentication, you must place the device on top of your head” followed by the request to “Perform the challenge action now.” The request may be a window on a display that illustrates the motion gesture requested that the individual perform and/or instructions for the motion gesture to be performed. At block 510 the challenge action response is received from the individual through, for example, a sensor. At block 512 the individual is authenticated based on at least the authentication information and the challenge action response.

The method 500 may be implemented in a client/server system as described above with reference to FIG. 3 and FIG. 4. According to one embodiment, the server may provide the random selection of a challenge action and transmit the selection to the device. The device then displays the challenge action to the user in the request for challenge action at block 508.

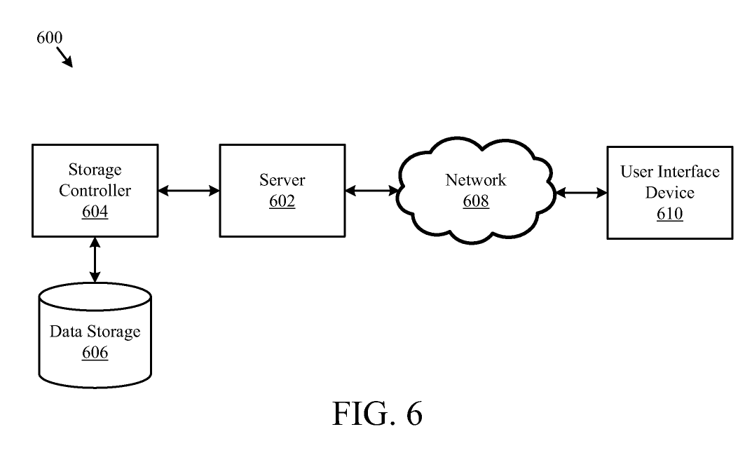

FIG. 6 illustrates one embodiment of a system 600 for an information system, such as an authentication system. The system 600 may include a server 602, a data storage device 606, a network 608, and a user interface device 610. The server 602 may be a dedicated server or one server in a cloud computing system. In a further embodiment, the system 600 may include a storage controller 604, or storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other a mobile communication device having access to the network 608. When the device 610 is a mobile device, sensors (not shown), such as a camera or accelerometer, may be embedded in the device 610. When the device 610 is a desktop computer the sensors may be embedded in an attachment (not shown) to the device 610. In a further embodiment, the user interface device 610 may access the Internet or other wide area or local area network to access a web application or web service hosted by the server 602 and provide a user interface for enabling a user to enter or receive information.

The network 608 may facilitate communications of data, such as authentication information, between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 610 accesses the server 602 through an intermediate sever (not shown). For example, in a cloud application the user interface device 610 may access an application server. The application server fulfills requests from the user interface device 610 by accessing a database management system (DBMS), which stores authentication information and associated challenge actions. In this embodiment, the user interface device 610 may be a computer or phone executing a Java application making requests to a JBOSS server executing on a Linux server, which fulfills the requests by accessing a relational database management system (RDMS) on a mainframe server.

In one embodiment, the server 602 is configured to store databases, pages, tables, and/or records having authentication information. Additionally, scripts on the server 602 may access data stored in the data storage device 606 via a storage area network (SAN) connection, a LAN, or a data bus. The data storage device 606 may include, for example, a hard disk, including hard disks arranged in an redundant array of independent disks (RAID) array, a tape storage drive comprising a physical or virtual magnetic tape data storage device, or an optical storage device. The data may be arranged in a database and accessible through structured query language (SQL) queries, or other data base query languages or operations.

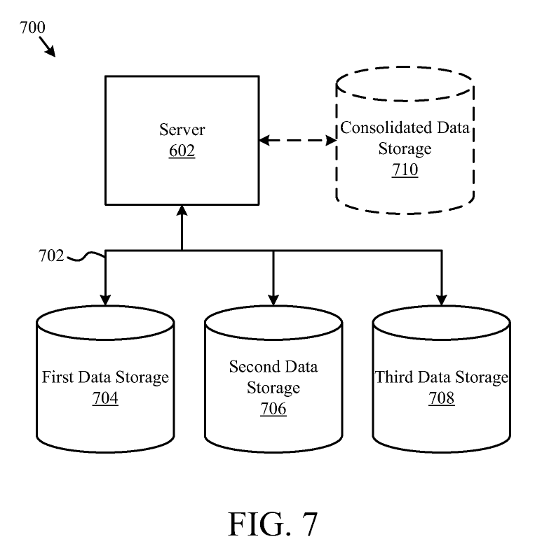

FIG. 7 illustrates one embodiment of a data management system 700 configured to store authentication information. In one embodiment, the data management system 700 may include the server 602. The server 602 may be coupled to a data-bus 702. In one embodiment, the data management system 700 may also include a first data storage device 704, a second data storage device 706, and/or a third data storage device 708. In further embodiments, the data management system 700 may include additional data storage devices (not shown). In such an embodiment, each data storage device 704, 706, and 708 may each host a separate database that may, in conjunction with the other databases, contain redundant data. Alternatively, a database may be spread across storage devices 704, 706, and 708 using database partitioning or some other mechanism. Alternatively, the storage devices 704, 706, and 708 may be arranged in a RAID configuration for storing a database or databases that may contain redundant data. Data may be stored in the storage devices 704, 706, 708, 710 in a database management system (DBMS), a relational database management system (RDMS), an object oriented database management system (OODMS), an indexed sequential access method (ISAM) database, a multi-sequential access method (MSAM) database, a conference on data systems languages (CODASYL) database, or other database system.

In one embodiment, the server 602 may submit a query to select data from the storage devices 704 and 706. The server 602 may store consolidated data sets in a consolidated data storage device 710. In such an embodiment, the server 602 may refer back to the consolidated data storage device 710 to obtain a set of records. Alternatively, the server 602 may query each of the data storage devices 704, 706, and 708 independently or in a distributed query to obtain the set of data elements. In another alternative embodiment, multiple databases may be stored on a single consolidated data storage device 710.

In various embodiments, the server 602 may communicate with the data storage devices 704, 706, and 708 over the data-bus 702. The data-bus 702 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 602 may communicate indirectly with the data storage devices 704, 706, 708, and 710 by first communicating with a storage server (not shown) or the storage controller 604.

The server 602 may include modules for interfacing with the data storage devices 704, 706, 708, and 710, may include modules for interfacing with the network 608, and/or modules for interfacing with a user through the user interface device 610. In a further embodiment, the server 602 may host an engine, application plug-in, or application programming interface (API).

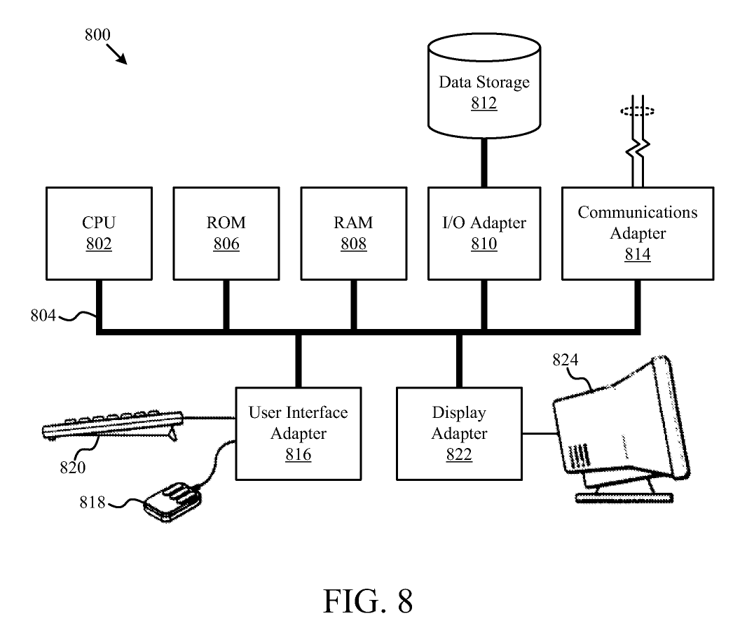

FIG. 8 illustrates a computer system 800 adapted according to certain embodiments of the server 602 and/or the user interface device 610. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the modules and operations as described herein. The CPU 802 may execute the various logical instructions according to the present embodiments.

The computer system 800 also may include random access memory (RAM) 808, which may be synchronous RAM (SRAM), dynamic RAM (DRAM), and/or synchronous dynamic RAM (SDRAM). The computer system 800 may utilize RAM 808 to store the various data structures used by a software application such as databases, tables, and/or records. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a flash drive, a compact disc (CD) drive, a floppy disk drive, and a tape drive, to the computer system 800. The communications adapter 814 may be adapted to couple the computer system 800 to the network 608, which may be one or more of a LAN, WAN, and/or the Internet. The communications adapter 814 may be adapted to couple the computer system 800 to a storage device 812. The user interface adapter 816 couples user input devices, such as a keyboard 820, a pointing device 818, and/or a touch screen (not shown) to the computer system 800. The display adapter 822 may be driven by the CPU 802 to control the display on the display device 824.

The applications of the present disclosure are not limited to the architecture of computer system 800. Rather the computer system 800 is provided as an example of one type of computing device that may be adapted to perform the functions of a server 602 and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
requesting authentication information for an individual;
receiving authentication information for the individual;
presenting the individual with a random challenge action;
receiving a response to the challenge action from the individual; and
authenticating the individual based at least on the authentication information and the challenge action response.

2. The method of claim 1, in which the step of authenticating comprises:
identifying the individual based on at least the authentication information; and
verifying the individual is present at a device based on at least the challenge action response.

3. The method of claim 2, in which the challenge action is a motion gesture comprising at least one of moving the device in a circle clockwise, moving the device in a circle counter-clockwise, shaking the device, shaking the device with a twisting motion, moving the device in a figure-eight pattern, moving the device back and forth at waist level, and placing the device on top of the individual's head.

4. The method of claim 3, in which the response to the challenge action is received through at least one of a still camera, a motion camera, a microphone, an accelerometer, and a gyroscope.

5. The method of claim 4, in which the motion gesture further comprises repeating the motion.

6. The method of claim 3, in which the step of requesting authentication information and the step of presenting a challenge action are performed by a client application, and in which the authenticating step comprises:
transmitting, to a server, the authentication information and the challenge action response; and
receiving, from the server, an authentication message indicating at least one of allow access and deny access.

7. The method of claim 6, further comprising receiving, from the server, a configuration for a client device for the individual.

8. The method of claim 7, in which the client device is a mobile device.

9. A computer program product, comprising:
a non-transitory computer-readable medium comprising:
code to request authentication information for an individual;
code to receive authentication information for the individual;
code to present the individual with a random challenge action;
code to receive a response to the challenge action from the individual; and
code to authenticate the individual based at least on the authentication information and the challenge action response.

10. The computer program product of claim 9, in which the medium further comprises:
code to identify the individual based on at least the authentication information; and
code to verify the individual is present at a device based on at least the challenge action response.

11. The computer program product of claim 10, in which the challenge action is a motion gesture.

12. The computer program product of claim 11, in which the code to verify comprises code to detect at least one of moving the device in a circle clockwise, moving the device in a circle counter-clockwise, shaking the device, shaking the device with a twisting motion, moving the device in a figure-eight pattern, moving the device back and forth at waist level, and placing the device on top of the individual's head.

13. The computer program product of claim 12, in which the code to detect comprises code to detect repeating the motion.

14. The computer program product of claim 11, in which the step of requesting authentication information and the step of presenting the challenge action are performed by a client application, and in which the medium further comprises:
code to transmit, to a server, the authentication information and the challenge action response; and
code to receive, from the server, an authentication message indicating at least one of allow access and deny access.

15. The computer program product of claim 14, in which the medium further comprises code to receive, from the server, a configuration for a client device for the individual.

16. A system, comprising:
a memory;
a sensor;
at least one processor coupled to the memory and coupled to the sensor, in which the at least one processor is configured:
to request authentication information for an individual;
to receive authentication information for the individual;
to present the individual with a random challenge action;
to receive a response to the challenge action request from the individual through the sensor; and
to authenticate the individual based at least on the authentication information and the challenge action response.

17. The system of claim 16, in which the at least one processor is further configured:
to identify the individual based on at least the authentication information; and
to verify the individual is present at a device based on at least the challenge action response.

18. The system of claim 17, in which the challenge action is a motion gesture and the at least one processor is further configured to detect at least one of moving the device in a circle clockwise, moving the device in a circle counter-clockwise, shaking the device, shaking the device with a twisting motion, moving the device in a figure-eight pattern, moving the device back and forth at waist level, and placing the device on top of the individual's head.

19. The system of claim 16, further comprising a server, in which the at least one processor is configured:
to transmit, to a server, the authentication information; and
to receive, from the server, a response indicating at least one of allow access or deny access.

20. The system of claim 19, in which the at least one processor is further configured to receive, from the server, a configuration for a client device for the individual.
